(19) United States
(12) Patent Application Publication
(10) Pub. No.: US 2012/0159314 A1
(43) Pub. Date: Jun. 21, 2012

(54) ADAPTIVE CONTENT LAYOUT

(75) Inventors: Evan J. Schrier, Fall City, WA (US); Charles E. Jacobs, Seattle, WA (US)

(73) Assignee: MICROSOFT CORPORATION, Redmond, WA (US)

(21) Appl. No.: 12/970,191

(22) Filed: Dec. 16, 2010

(51) Int. Cl. G06F 17/00

(52) U.S. Cl. 715/252; 715/253

(57) ABSTRACT

Various embodiments provide techniques for adaptive content layout. In at least some embodiments, templates are provided that can be utilized to adapt content for a particular device and/or display configuration. A template can be embodied in a variety of different ways, such as XML code (or other markup code), script code, a component object model (COM) object, and so on. Examples of content that can be adapted using a template include video content, images, web pages, and so on. According to some embodiments, each template can include one or multiple elements that can be populated with content. An element can have a particular size layout, such as a width and height (e.g., in pixels) and content can be reformatted and/or resized based on attributes (e.g., size and/or shape) of the element.

### BACKGROUND

Today's online environment presents users with a tremendous variety of available content. For example, a user can utilize a device to navigate the web and discover content such as web pages, videos, images, and so on. The format of some content, however, may be such that the content may not be visually appealing when the content is displayed on a particular device. For example, when a mobile device displays a web page that is designed for a large display area, the web page may be awkwardly resized and/or reformatted to fit the smaller display area of the mobile device. This can reduce a user's enjoyment of online content and cause users to avoid certain content, such as a particular web page that does not display properly on the user's device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide techniques for adaptive content layout. In at least some embodiments, templates are provided that can be utilized to adapt content for a particular device and/or display configuration. A template can be embodied in a variety of different ways, such as XML code (or other markup code), script code, a component object model (COM) object, and so on. Examples of content that can be adapted using a template include video content, images, web pages, and so on. According to some embodiments, each template can include one or multiple elements that can be populated with content. An element can have a particular size layout, such as a width and height (e.g., in pixels) and content can be reformatted and/or resized based on attributes (e.g., size and/or shape) of the element.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates an example content layout scenario in accordance with one or more embodiments.

FIG. 3 illustrates an example method in accordance with one or more embodiments.

FIG. 4 illustrates an example method in accordance with one or more embodiments.

FIG. 5 illustrates a content page that is rendered using an example template in accordance with one or more embodiments.

FIG. 6 illustrates an example system that can be used to implement one or more embodiments.

### DETAILED DESCRIPTION

Overview

Various embodiments provide techniques for adaptive content layout. In at least some embodiments, templates are provided that can be utilized to adapt content for a particular device and/or display configuration. A template can be embodied in a variety of different ways, such as XML code (or other markup code), script code, a component object model (COM) object, and so on. Examples of content that can be adapted using a template include video content, images, web pages, and so on. According to some embodiments, each template can include one or multiple elements that can be populated with content. An element can have a particular size layout, such as a width and height (e.g., in pixels) and content can be reformatted and/or resized based on attributes (e.g., size and/or shape) of the element.

In at least some embodiments, a device can be associated with a variety of different templates. The templates can be formatted for a display size (e.g., screen size) of the device and can be stored locally on the device and/or at a remote resource, such as a server. When the device receives content, the templates can be sorted to determine which of the templates is to be used to lay out the content for display on the device.

Consider the following example implementation scenario in accordance with some embodiments. A user of a mobile device uses a web browser running on the mobile device to navigate to a web page. The mobile device receives the web page content, such as markup and/or other code that defines the features of the web page. Features of the web page can include images, text boxes, navigation features, hyperlinks, and so on. The web browser or other application inspects the web page content for attributes such as the height, width, and nested depth of the features of the web page. The device then sorts a set of templates based on the attributes and selects a template that is a “best fit” for displaying the web page. For example, a score can be calculated for each of the templates based on a variety of factors, such as a correspondence between template element sizes and web site feature sizes, a comparison of a number of template elements with a number of web site features, a template element's ability to display a particular web site feature with minimal resizing, and so on. A template with the highest score can then be used to lay out the web page for display. In at least some embodiments, the selected template can be passed to a rendering engine to be used to render the web page for display on the device.

In the discussion that follows, a section entitled “Operating Environment” is provided and describes one environment in which one or more embodiments can be employed. Following this, a section entitled “Example Content Layout Scenario” describes an example content layout scenario in accordance with one or more embodiments. Next, a section entitled “Example Methods” describes example methods in accordance with one or more embodiments. Following this, a section entitled “Example Template” describes an example template and an example implementation of the template in accordance with one or more embodiments. Last, a section entitled “Example System” describes an example system that can be utilized to implement one or more embodiments.

Operating Environment

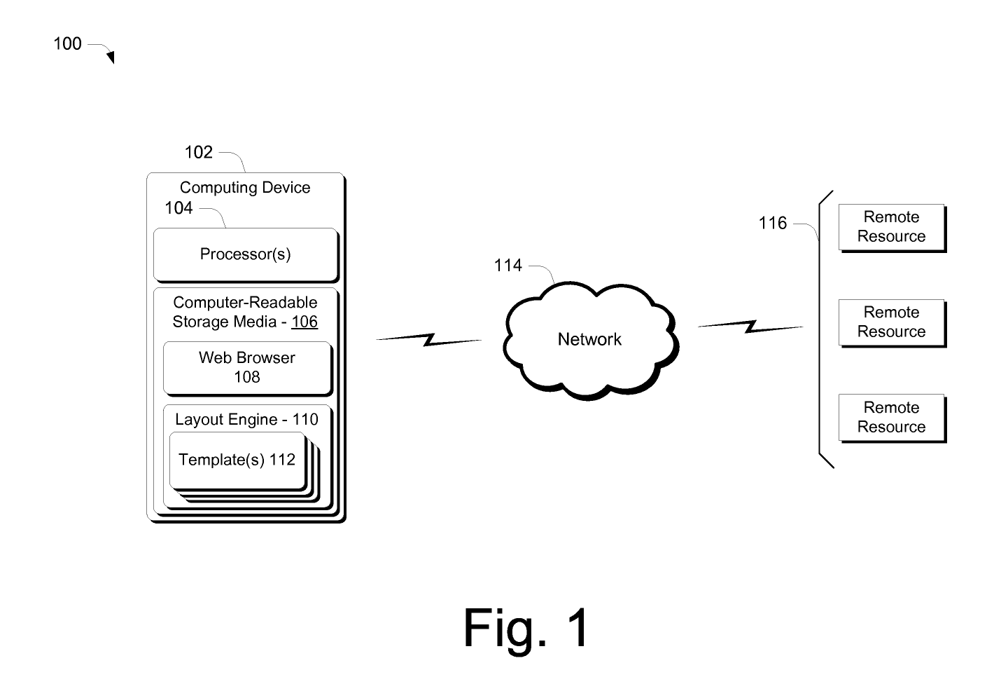

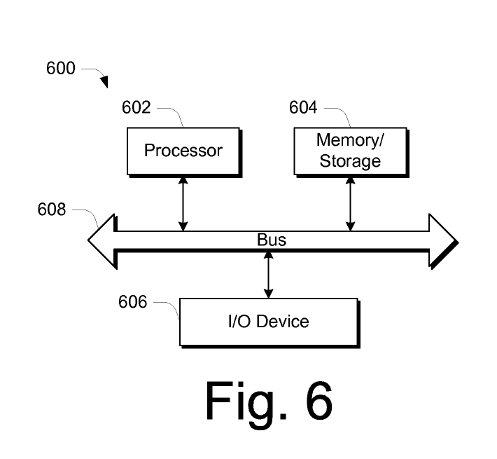

FIG. 1 illustrates an operating environment in accordance with one or more embodiments, generally at 100. Environment 100 includes a computing device 102 having one or more processors 104 and one or more computer-readable storage media 106. The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 6.

In addition, computing device 102 includes an application in the form of a web browser 108 that can be utilized via the computing device to access content such as a web page. The computing device 102 also includes a layout engine 110 that includes and/or makes use of one or more templates 112. In at least some embodiments, a template includes data that defines grid-based elements of a display, such as a display screen of a device. For example, a template can be associated with particular screen coordinates and can define a particular section or sections of a display. Also in some embodiments, each of the templates 112 can include a unique set of constraint data that can be used to determine particular aspects of the template, such as relationships between the elements of a template. For example, the constraint data can be used (e.g., by the web browser 108) to determine aspects of a template for display, such as a size, shape, and/or display position of the template and/or elements of the template. In at least some embodiments, the constraint data can also define how a particular template element is to be visually oriented with respect to other template elements. According to some embodiments, functionalities of the layout engine 110 can be controlled and/or implemented by the web browser 108. Thus, in some alternate embodiments, techniques discussed herein can be implemented by the web browser 108 without requiring a separate layout engine.

In at least some embodiments, the layout engine 110 is configured to inspect content and select one of the templates 112 to be used to lay out the content. Example ways of selecting a template for laying out content are discussed above and below.

In addition, environment 100 includes a network 114, such as the Internet, and one or more remote resources 116 with which the computing device 102 can communicate. Examples of the remote resources 116 include a remote web server, a cloud computing resource, and so on. In some example embodiments, the computing device 102 can retrieve content and/or templates from the remote resources 116.

Computing device 102 can be embodied as any suitable computing device such as, by way of example and not limitation, a desktop computer, a portable computer, a handheld computer such as a personal digital assistant (PDA), cell phone, and the like.

Having described an example operating environment, consider now a discussion of an example content layout scenario utilizing the techniques and tools discussed herein.

Example Content Layout Scenario

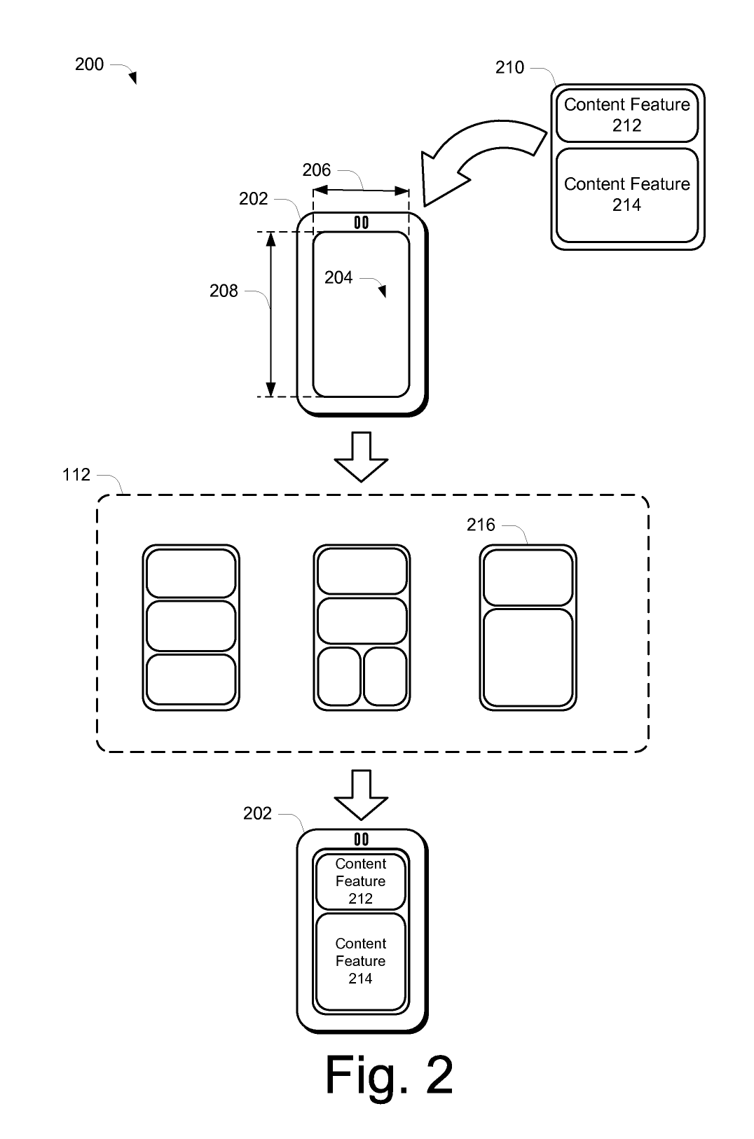

FIG. 2 illustrates an example content layout scenario utilizing techniques and/or tools discussed herein, generally at 200. The content layout scenario 200 includes a device 202 that can be used to access and display content. In at least some embodiments, the device 202 can be embodied as the computing device 102 discussed above with respect to FIG. 1. The device 202 includes a display area 204 that has a width 206 and a height 208. In at least some embodiments, the width 206 and the height 208 can indicate an area in pixels in which content can be displayed. For example, the width 206 can be 480 pixels and the height 208 can be 800 pixels to indicate a total area of 480×800 pixels.

As part of the content layout scenario 200, the device 202 receives content 210 that includes a content feature 212 and a content feature 214. In at least some embodiments, the content 210 can include a web page and the content feature 212 and/or the content feature 214 can include web page features such as images, video, text, navigation features, and so on. According to some embodiments, the content 210 can be received by the device 202 responsive to a navigation to the content via a web browser, e.g., the web browser 108.

According to at least some embodiments, the device 202 is associated with the templates 112 discussed above with respect to operating environment 100. When the device 202 receives the content 210, the templates 112 can be sorted to determine a template that can be used to render the content 210 on the device. For example, the layout engine 110 (discussed above with respect to operating environment 100) can ascertain various attributes of the content feature 212 and/or the content feature 214 and select one of the templates 112 to be used to lay out the content features. Example techniques for selecting templates to be used to lay out and/or render content are discussed above and below.

Further to the content layout scenario 200, a template 216 of the templates 112 is selected to be used to render the content 210. In at least some embodiments, the template 216 and the content features 212 and 214 are processed (e.g., by a rendering engine associated with the device 202) to render all or part of the content 210 on the device 202. For example, the content features 212 and 214 and the template 216 can be rendered to generate markup (e.g., HTML) and a style sheet (e.g., according to cascading style sheet language (CSS)) to be used to display the content 210. The content 210 can then be displayed by the device 202 (e.g., via the web browser 108) using the markup and the style sheet.

Having described an example content layout scenario, consider now some example methods in accordance with one or more embodiments.

Example Methods

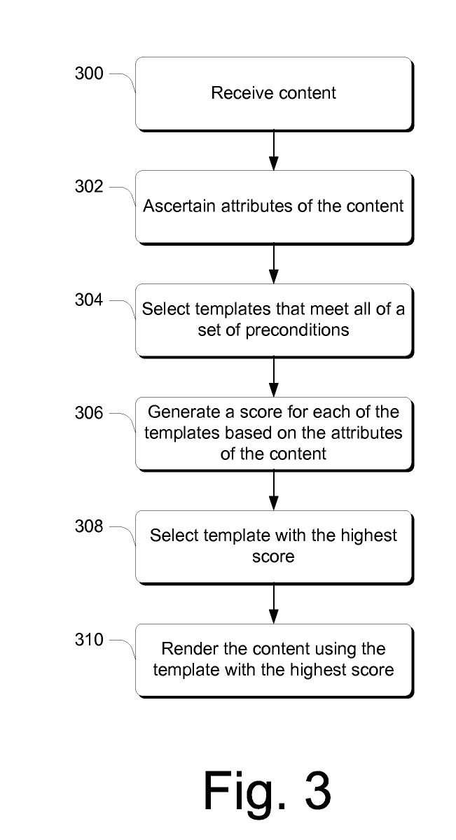

FIG. 3 is a flow diagram that describes steps a method in accordance with one or more embodiments. The method can be implemented in connection with any suitable hardware, software, firmware, or combination thereof. In at least some embodiments, the method can be implemented via a layout engine, such as the one described above. Also in some embodiments, the method can be implemented by a client device (e.g., the computing device 102) without requiring interaction with a server to determine content layout and/or template processing.

Step 300 receives content. For example, a computing device (e.g., the computing device 102) can receive content associated with a web page in response to a navigation to the web page via the web browser 108. Step 302 ascertains attributes of the content. Examples of attributes of content can include aspects such as height, width, display resolution, nested depth of content features, the type of content, and so on.

Step 304 selects templates that meet all of a set of preconditions. One example method for selecting templates based on preconditions is discussed below in accordance with one or more embodiments. In at least some embodiments, the selected templates are converted to Java script object notation (JSON) such that the templates can be interpreted and/or processed by a browser, e.g., the web browser 108. Step 306 generates a score for each of the templates based on the attributes of the content. In at least some embodiments, a score for a template can be generated by solving a system of constraints to evaluate a layout for the content. According to one or more embodiments, when the templates are converted to JSON, the system of constraints can be solved by a JavaScript® constraint solver. For example, a score for a particular template can consider correspondence between a size of a content feature and a size of an element of the template. A template with a higher correspondence can be given a higher score than a template with a lower correspondence. As another example, if a first template can fit content within a single viewable page whereas a second template cannot, the first template can be given a higher score than the second template.

A template can also be scored based on a correspondence between a number of content features and a number of template elements. For example, if the content has three features (e.g., an image and two text boxes), a template with three elements can be scored higher than a template with two elements. A score for a template can also consider the template's ability to fit particular content within an element of the template. For example, if text from the content can fit within an element for a first template with less visual crowding (e.g., greater readability) than an element for a second template, the first template can be scored higher than the second template. Other attributes of content and/or templates can be considered in generating a score for a template without departing from the spirit and scope of the claimed embodiments.

Step 308 selects a template with the highest score. Step 310 renders the content using the template with the highest score. In at least some embodiments, the content and the template with the highest score can be processed by a rendering engine and displayed according to a layout associated with the template.

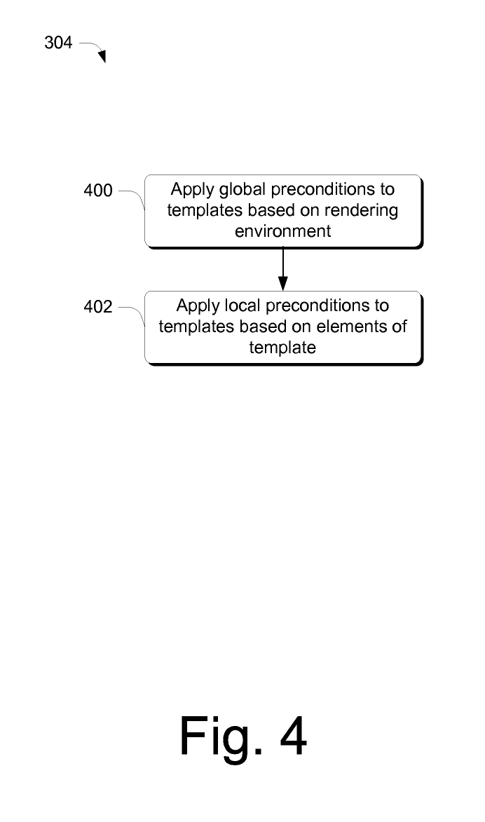

FIG. 4 is a flow diagram that describes step 304 of FIG. 3 in more detail in accordance with one or more embodiments. Step 400 applies global preconditions to the templates based on a rendering environment. For example, the global preconditions can include a screen size of a device on which the content is to be rendered and a set of templates can be selected that correspond to the screen size. In at least some embodiments, global preconditions can also include aspects of content (e.g., constraints) such as a size of a content feature.

Step 402 applies local preconditions to the templates based on elements of the templates. In at least some embodiments, applying global preconditions can include applying constraints associated with a template and/or a template element on a per-element basis such that individual elements of a template can be accepted or rejected. For example, a size of an element within a template (e.g., width and/or height) can be compared with a size of a content feature to determine if there is an approximate correspondence between the two. Additional examples of applying local preconditions include comparing a number of elements within a template to a number of content features, comparing a number of nested elements within a template to a number of nested elements associated with an instance of content, and so on. Templates that meet and/or correspond with the global and local preconditions can then be selected.

Having described methods in accordance with one more embodiments, consider now an example template that can be utilized to implement one or more embodiments.

Example Template

The following is an example of a template that can be used to implement various techniques discussed herein in accordance with one or more embodiments. According to some embodiments, this example template can be used to reformat content to fill a page (e.g., all or part of a display area) and to use advertisements to fill remaining space in the page.

<template2 id=″NYT-artT-F4″ version=″2.0″ >

```
<style align=″justified″ dropcap=″false″ >
  <font face=″Times″ size=″12″ leading=″1.2″ style=″regular″ />
  <color fg=″″ bg=″″ border=″″ />
</style>
<stylesheet src=″nytArt1.styl″ />
<preconditions>
```

// this is only valid as a top-level template

<precondition type=″value″ var=″page.depth″ maxValue=″0″ />
</preconditions>
// The adaptive grid uses as many columns of the minimum width as will fit.
// Columns that it doesn't have room for have a width of zero, so they drop

seamlessly out.

<grid type=″variable″ columns=″6″ Margins=″5″ prop=″1.0″ > // Maximum

of 6 columns

```
  <adaptive minColumnWidth=″200″ /> // of at least 200 pixels width
</grid>
<elements>
  // the flag has the highest layer so it will be layed out first.
  <element id=″flag″ layer=″6″ template-src=″NYT-inside-flag.tp2″ > // This
```

element is the header

// it consumes from the inside flag stream, (it's a top-level interior story)

<content content-src=″inside-flag″ />

// It spans all six columns and has a height of 200 pixels

<location column=″col1-col6″ top=″page.top″ height=″200″ />
</element>
// recompute height means the content can take as much space as it needs to

display all of it's

// content, But it will only use as much height as it needs to display the total

content and it will

// return the height actually used. That is why it must be on a higher layer

than the stuff that

// fills in beneath it.
// use template ″NYT-StoryHead.tp2″ and return the height actually used

<element id=″title″ layer=″5″ recomputeHeight=″true″ template-src=″NYT-
StoryHead.tp2″>

<preconditions>

// minimum 1 column maximum 6
<precondition type=″value″ var=″page.columns″ minValue=″1″ maxValue=″6″
/>

// only appears on page 1 of a multiple page document.

<precondition type=″value″ var=″page.pagenum″ maxValue=″1″ />
</preconditions>

| | |
|---|---|
| <content content-src=″header″ /> | // it consumes content from the header |

stream

// this template will only be used if the story spans exactly 4 columns, so the

headline

// will only span four columns as well.

<location column=″col1-col4″ top=″flag1.bottom″ height=″page.height-

flag1.bottom″ />

// It stretches to the bottom of the page but will report the height used at

display time.

| | |
|---|---|
| <pass-stylesheet current=″1″ /> | // pass the current stylesheet to the |

subtemplate

```
  <padding sides=″8″/>
  // pass the number of columns of the current (macro !THIS!) element to sub-
```

template

<pass-constraint var=″page.columns″ value=″!THIS!.columns″ />
</element>

// If there are only two columns the byline will stretch across both columns

<element id=″divider″ layer=″4″>
<preconditions>

// If there are three or more columns the by line will be in just the first column
so we need a divider

<precondition type=″value″ var=″page.columns″ minValue=″3″ /> // If

there are at least three columns draw a black line the first column

| | |
|---|---|
| </preconditions> | // of the title. |

| <style id=″blackLine″ /> | |
|---|---|
| <padding sides=″col1.width * 0.15″ top=″2″ /> | // make it shorter the |

the column.

| <location column=″col1″ top=″title1.bottom″ height=″3″ /> | |
|---|---|
| </element> | |
| <element id=″byline″ layer=″4″ recomputeHeight=″true″> | // put the |

byline under the the black line.

<preconditions>

<precondition type=″value″ var=″page.columns″ minValue=″3″ />

```
  </preconditions>
  <content content-src=″author″ />
  <style id=″byline″ />
  <padding ends=″5″ sides=″5″/>
  <location column=″col1″ top=″divider1.bottom″ height=″200″ />
</element>
  // this is the logic to make sure the page is filled
  // in each top-level element you can define any number of location nodes.
```

Each location node

// has a monotonically increasing subscript. It is one-based so the first

instance is body1 in

```
  // the case of an element called “body”.
<element id=″body″ layer=″2″ recomputeHeight=″true″>
  <preconditions>
```

<precondition type=″value″ var=″page.columns″ minValue=″3″ />

```
  </preconditions>
  <content content-src=″body″ />
  <style id=″body″ />
  <padding sides=″8″ bottom=″5″/>
  <location column=″col1″ top=″title1.bottom″ height=″page.height-
```

title1.bottom″ noLayoutPenalty=″−10″/> // if this column isn't filled it
generates a penalty of −10

<location column=″col2″ top=″title1.bottom″ height=″page.height-

title1.bottom″ noLayoutPenalty=″−10″/> // ditto

<location column=″col3″ top=″title1.bottom″ height=″page.height-

title1.bottom″ noLayoutPenalty=″−10″ /> // ditto

// This column has the attribue ″must complete stream″ if it doesn't complete

the stream it generates a badLayoutPenalty of −25.

<location column=″col4″ top=″title1.bottom″ height=″page.height-

title1.bottom″ noLayoutPenalty=″−10″ mustCompleteStream=″true″
badLayoutPenatly=″−25″/>

</element>
// this is the logic to fill the remaining space with advertising.
<element id=″advert″ layer=″1″ assign-content-on-layout=″true″ template-

src=″tiny.tp″>

<content content-src=″ads″ />

// the first ad stretches from the bottom of the last body column to the

bottom of

```
  // the page or a maximum height of 350.
  <padding all=″10″ />
  <location column=″col4″ top=″body4.bottom″ height=″min(page.bottom-
```

body4.bottom, 350)″ />

// this puts a second ad under the first ad if the first doesn't reach the bottom

of the page.

```
  <location column=″col4″ top=″advert1.bottom″ bottom=″page.bottom″ />
  // this puts element puts an ad at the spanning the top of columns 5 & 6.
<location column=″col5-col6″ top=″flag1.bottom″ height=″min(page.bottom-
```

flag1.bottom, 400)″ />

```
  // This fills in the rest of column 5
  <location column=″col5″ under=″advert3″ bottom=″page.bottom″ />
  // this fill in the rest of column 6
  <location column=″col6″ under=″advert3″ bottom=″page.bottom″ />
</element>
// this is a white background layer.
<element id= ″background″ layer=″0″>
  <location top=″page.top″ bottom=″page.bottom″ column=″col1-col6″ />
  <style id=″background″ />
</element>
// this implements a photo group. A photo group is a structure that can have
```

multiple photo

// elements defined and this one is programmed to use the first one that

doesn't have a negative

// score. That is what the ″first-good″ group type means. There can be best-fit

where it would

// try all elements and take the highest score. This only distinguishes between

portrait and

```
// landscape aspect ratio, so first-fit will be fine
<group id=″photo-groupA″ grouptype=″firstgood″ layer=″3″>
  <content content-src=″photo″ />
  <preconditions>
```

<precondition type=″value″ var=″page.height″ minValue=″500″/> // it

requires at least 500 pixels of page height

<precondition type=″content″ content-src=″photo″ minItems=″1″ /> // and

one or more photos in the photo stream

```
  </preconditions>
  <element id=″figureA″ layer=″3″ template-src=″NYT-figcap-param.tp2″
```

recomputeHeight=″true″ >

<content content-src=″photo″ /> // it consumes the photo stream
<location column=″col2-col3″ bottom=″page.bottom″ height=″page.bottom-

title.bottom″ > // It spans columns 2 and 3

// this passes a constraint saying that it wants a photo in ″landscape″ aspect

ration

```
  // wider than it is tall.
  <pass-constraint var=″target.aspect″ value=″1″ /> // </location>
<location column=″col2″ bottom=″page.bottom″ height=″page.bottom-
```

title.bottom″ >

// This photo is one column, and prefers a ″portrait″ aspect ratio (taller than

it is wide)

// the codes 1 and 0 are arbitrary.
<pass-constraint var=″target.aspect″ value=″0″ />
</location>
<paddingends=″10″ />
<constraint var=″!THIS!.score″ value=″!THIS!.template.score″ />

```
  </element>
  // This sets a top constraint to the greater of the top value. The value that
```

wasnt used will be zero.

<constraint var=″figureA.top″ value=″max(figureA1.top, figureA2.top)″ />
</group>
</elements>
<constraints> // The final score is the sum of all of the body scores.

<constraint var=″template.score″
value=″body1.score+body2.score+body3.score+body4.score″ />

</constraints>

</template2>

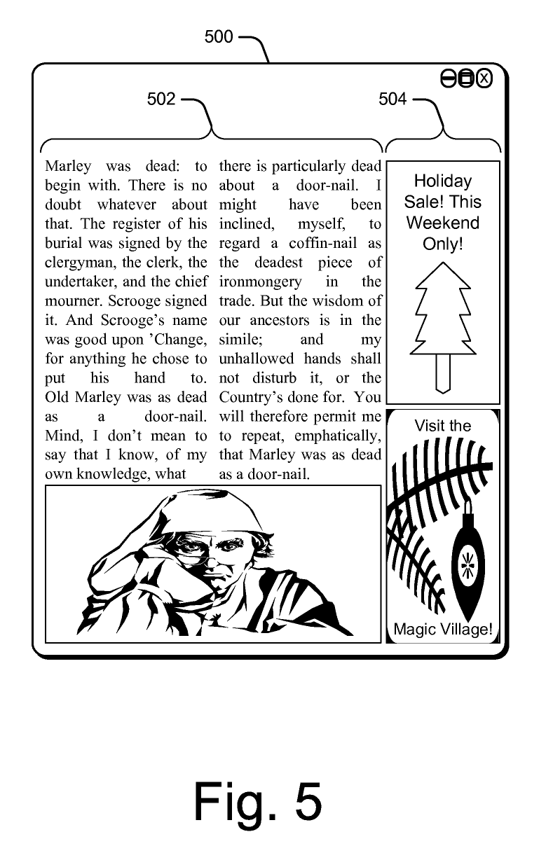

FIG. 5 illustrates a content page 500 that is rendered using the example template above in accordance with one or more embodiments. In at least some embodiments, the content included as part of the content page 500 can be received as part of a web page and can be reformatted (e.g., by the layout engine 110) using the example template. The example template can be used to reformat content using a variable number of columns, and as illustrated the template has been used to format the content page 500 to include a content area 502 with two columns of text content and a landscape-oriented photo beneath the text content. Additionally, the content page 500 includes an advertising area 504 that has been populated with advertisements as specified in the advertising portion of the example template.

Having described an example template in accordance with one more embodiments, consider now an example system that can be utilized to implement one or more embodiments.

Example System

FIG. 6 illustrates an example computing device 600 that can be used to implement the various embodiments described above. Computing device 600 can be, for example, computing device 102 and/or one or more of remote resources 116 of FIG. 1.

Computing device 600 includes one or more processors or processing units 602, one or more memory and/or storage components 604, one or more input/output (I/O) devices 606, and a bus 608 that allows the various components and devices to communicate with one another. Bus 608 represents one or more of any of several types of bus structures, including a memory bus or memory controller, a peripheral bus, an accelerated graphics port, and a processor or local bus using any of a variety of bus architectures. Bus 608 can include wired and/or wireless buses.

Memory/storage component 604 represents one or more computer storage media. Component 604 can include volatile media (such as random access memory (RAM)) and/or nonvolatile media (such as read only memory (ROM), Flash memory, optical disks, magnetic disks, and so forth). Component 604 can include fixed media (e.g., RAM, ROM, a fixed hard drive, etc.) as well as removable media (e.g., a Flash memory drive, a removable hard drive, an optical disk, and so forth).

One or more input/output devices 606 allow a user to enter commands and information to computing device 600, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide techniques for adaptive content layout. In at least some embodiments, templates are provided that can be utilized to adapt content for a particular device and/or display configuration. A template can be embodied in a variety of different ways, such as XML code (or other markup code), script code, a component object model (COM) object, and so on. Examples of content that can be adapted using a template include video content, images, web pages, and so on. According to some embodiments, each template can include one or multiple elements that can be populated with content. An element can have a particular size layout, such as a width and height (e.g., in pixels) and content can be reformatted and/or resized based on attributes (e.g., size and/or shape) of the element.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
ascertaining one or more attributes of content;
selecting a set of templates based on one or more preconditions, wherein at least one of the preconditions is based on the one or more attributes of the content;
generating a score for each template of the set of templates; and
selecting a template of the set of templates with the highest score to be used to render the content.

2. The computer-implemented method of claim 1, wherein the attributes of the content include one or more of a height of the content, a width of the content, or a nested depth of one or more features of the content.

3. The computer-implemented method of claim 1, wherein the preconditions include one or more global preconditions based on a rendering environment for the content.

4. The computer-implemented method of claim 3, wherein the global preconditions include a screen size of a device on which the content is to be rendered.

5. The computer-implemented method of claim 1, wherein the preconditions include one or more local preconditions based on elements of each template of the set of templates.

6. The computer-implemented method of claim 1, wherein generating the score for each template of the set of templates comprises:
determining a correspondence between a size of a content feature and a size of a template element; and
indicating a higher score for a template with a higher correspondence between the size of the content feature and the size of the template element than for a template with a lower correspondence between the size of the content feature and the size of the template element.

7. The computer-implemented method of claim 1, wherein generating the score for each template of the set of templates comprises:
determining a correspondence between a number of content features and a number of template elements; and
indicating a higher score for a template with a higher correspondence between the number of content features and the number of template elements than for a template with a lower correspondence between the number of content features and the number of template elements.

8. The computer-implemented method of claim 1, wherein generating the score for each template of the set of templates comprises indicating the highest score for the template that can fit the content with the least visual crowding.

9. One or more computer readable storage media embodying computer readable instructions comprising:
a set of templates, wherein one or more templates of the set of templates is configured to be used to render an instance of content; and
a layout engine configured to:
determine one or more attributes of the instance of content;
generate a score for each template of the set of templates based on the one or more attributes; and
select a template of the set of templates with the highest score to be used render the instance of content.

10. The one or more computer readable storage media of claim 9, wherein one or more templates of the set of templates includes constraint data to be used to configure the one or more templates for display.

11. The one or more computer readable storage media of claim 9, wherein one or more templates of the set of templates includes grid-based elements for a device display to be used in rendering the one or more templates and the instance of content.

12. The one or more computer readable storage media of claim 9, wherein each template of the set of templates is formatted for a specific rendering environment.

13. The one or more computer readable storage media of claim 9, wherein the attributes of the instance of content include one or more of a size of the instance of content or a nested depth of one or more features of the instance of content.

14. The one or more computer readable storage media of claim 9, wherein the layout engine is further configured to generate a score for each template of the set of templates by:
determining a correspondence between a size of one or more features of the instance of content and a size of one or more elements of each template of the set of templates; and
indicating a higher score for a template of the set of templates with a higher correspondence between the size of the one or more features of the instance of content and the size of the one or more elements of each template of the set of templates.

15. The one or more computer readable storage media of claim 9, wherein the layout engine is further configured to generate a score for each template of the set of templates by:
determining a correspondence between a number of features of the instance of content and a number of elements for each template of the set of templates; and
indicating a higher score for a template of the set of templates with a higher correspondence between the number of features of the instance of content and the number of elements for each template of the set of templates.

16. A computer-implemented method comprising:
selecting a set of templates based on one or more global preconditions, one or more local preconditions, and one or more attributes of an instance of content;
generating a score for each template of the set of templates; and
selecting a template of the set of templates with the highest score to be used to render the instance of content.

17. The computer-implemented method of claim 16, wherein the global preconditions comprise a screen size associated with a rendering environment for the instance of content.

18. The computer-implemented method of claim 16, wherein the local preconditions comprise one or more of a size of a template of the set of templates or a number of elements associated with the template.

19. The computer-implemented method of claim 16, wherein generating a score for each template of the set of templates comprises:
determining a correspondence between one or more attributes of each template of the set of templates and the one or more attributes of the instance of content; and
indicating the highest score for the template of the set of templates based on a higher correspondence between attributes of the template and the one or more attributes of the instance of content than for other templates of the set of templates.

20. The computer-implemented method of claim 16, further comprising:
generating markup and a style sheet using the template of the set of templates and the instance of content; and
displaying at least a portion of the instance of content using the markup and the style sheet.
